(19) United States
(12) Patent Application Publication
(10) Pub. No.: US 2026/0208637 A1
(43) Pub. Date: Jul. 23, 2026

(54) VEHICLE SEAT INCLUDING INFLATABLE DEVICE INFLATABLE DOWNWARDLY

(71) Applicant: Ford Global Technologies, LLC, Dearborn, MI (US)

(72) Inventors: Gustavo Morales Cabrera, Ecatepec de Morelos/Mexico (MX); Fernando Lozano Omaña, Cuauhtemoc/Mexico City (MX); Jesus Alfonso Alarcon Hernandez, Toluca (MX); Luis Alberto Miranda Linares, Cuautitlan Izcalli (MX)

(73) Assignee: Ford Global Technologies, LLC, Dearborn, MI (US)

(21) Appl. No.: 19/027,044

(22) Filed: Jan. 17, 2025

(51) Int. Cl. B60N 2/427; B60N 2/90

(52) U.S. Cl. CPC B60N 2/42763; B60N 2/929

(57) ABSTRACT

A vehicle includes a vehicle floor and a vehicle seat. The vehicle seat includes a seatback and a seat bottom rotatably connected to the seatback about a rotational axis. The seat bottom includes a proximal end at the seatback and a distal end distal to the seatback. An inflatable device is fixed to the distal end of the seat bottom. The inflatable device has a wall that is a thermoplastic elastomer. The wall defines an inflation chamber. The seat bottom is rotatable relative to the seatback about the rotational axis between a deployed position and a raised position. The inflatable device is moveable with the seat bottom between the deployed position and the raised position. With the seat bottom in the deployed position, the inflatable device is spaced from the floor in an uninflated position and is inflatable to the floor to an inflated position.

### BACKGROUND

A vehicle seat is disposed in an occupant cabin of a vehicle to support an occupant during operation of the vehicle. The vehicle seat includes a seat bottom and a seatback. The seat bottom has a pelvis area that supports the pelvis of the occupant.

The vehicle includes a seatbelt assembly for each occupant to control the kinematics of the occupant relative to the seat in response to a vehicle acceleration caused by the vehicle impact. The seatbelt assembly includes a lap belt that extends across the lap of the occupant when buckled. During certain vehicle impacts, the pelvis of the occupant may be forced in a downward direction in compression against the pelvis area of the seat bottom and away from the lap belt of the seatbelt assembly.

### BRIEF DESCRIPTION OF THE DRAWINGS

FIG. 1 is a cut-away perspective view of a vehicle including a rear seat including three inflatable devices each in an uninflated position.

FIG. 2 is a perspective view of the rear seat.

FIG. 3 is a perspective view of the rear seat with one of the seat bottoms in a raised position.

FIG. 4 is a side view of the rear seat with one of the seat bottoms in the raised position.

FIG. 5 is a perspective view of the rear seat with each of the inflatable devices in an inflated position.

FIG. 6 is a side view of the rear seat with each the inflatable devices in the inflated position.

### DETAILED DESCRIPTION

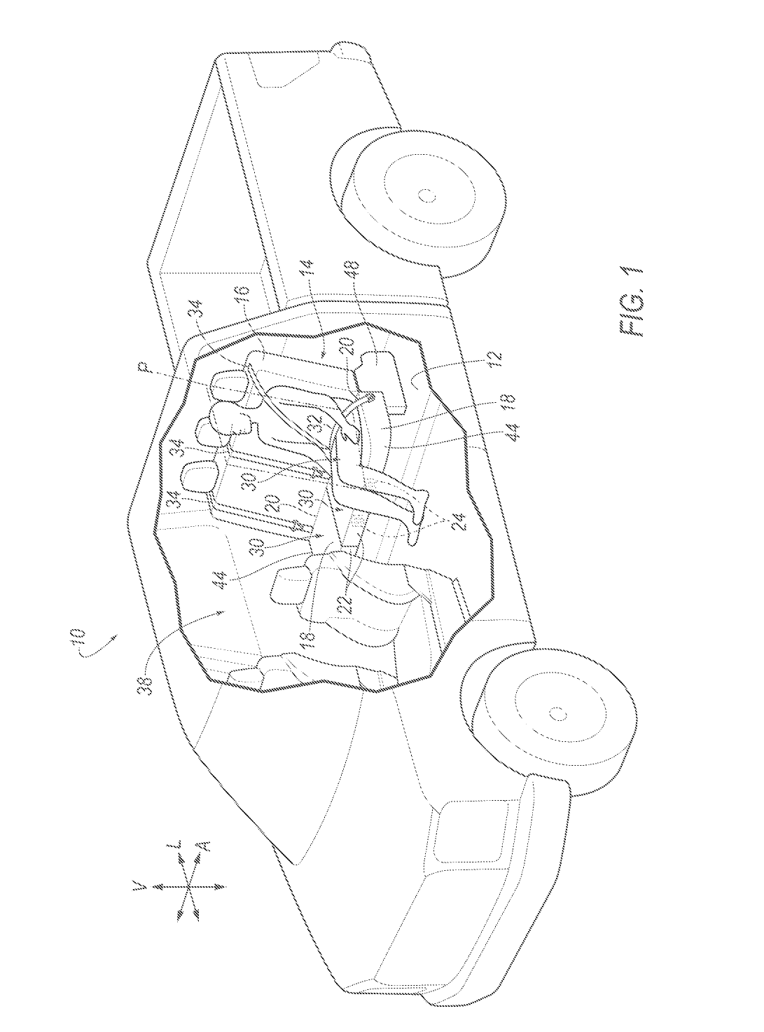

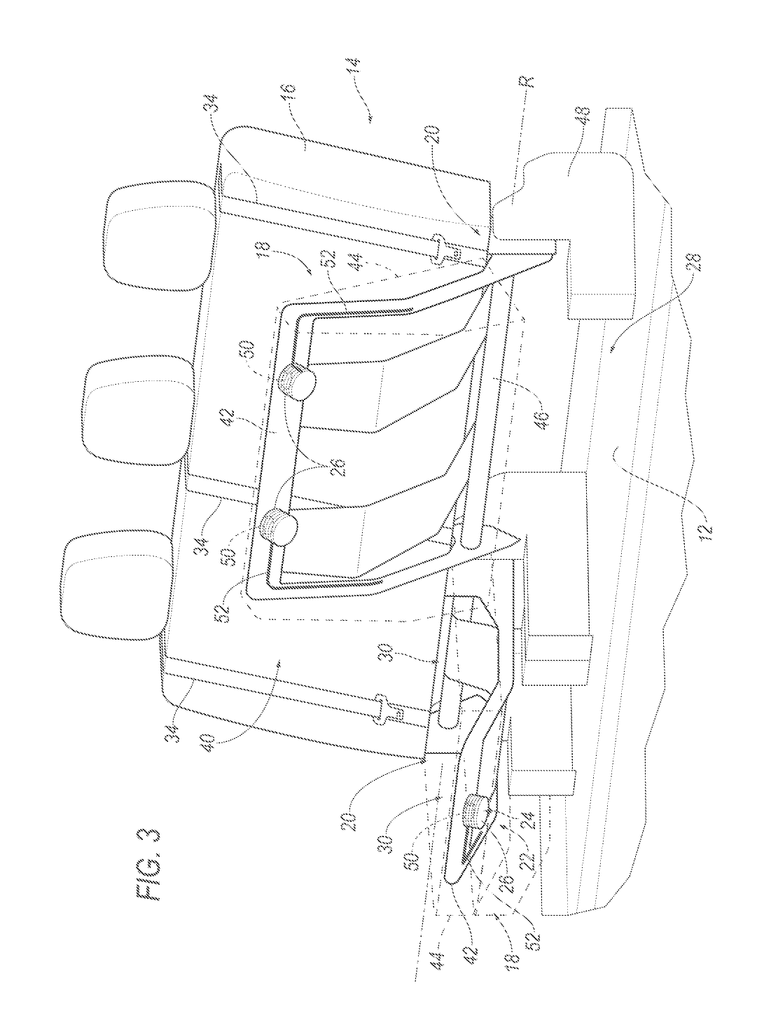

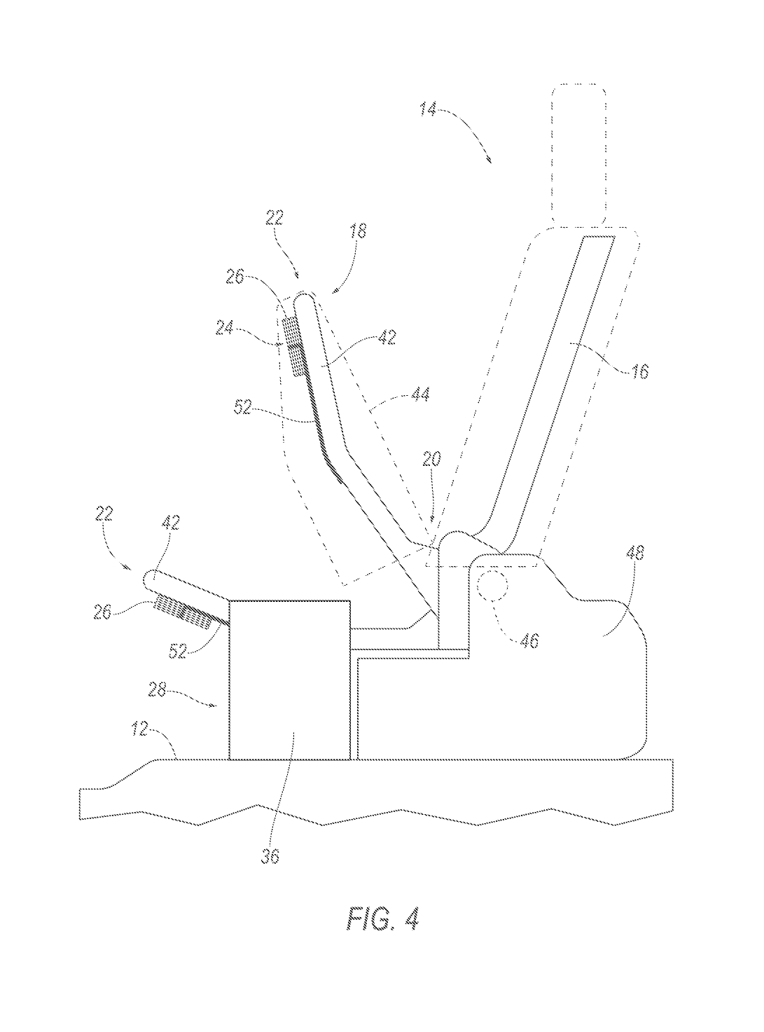

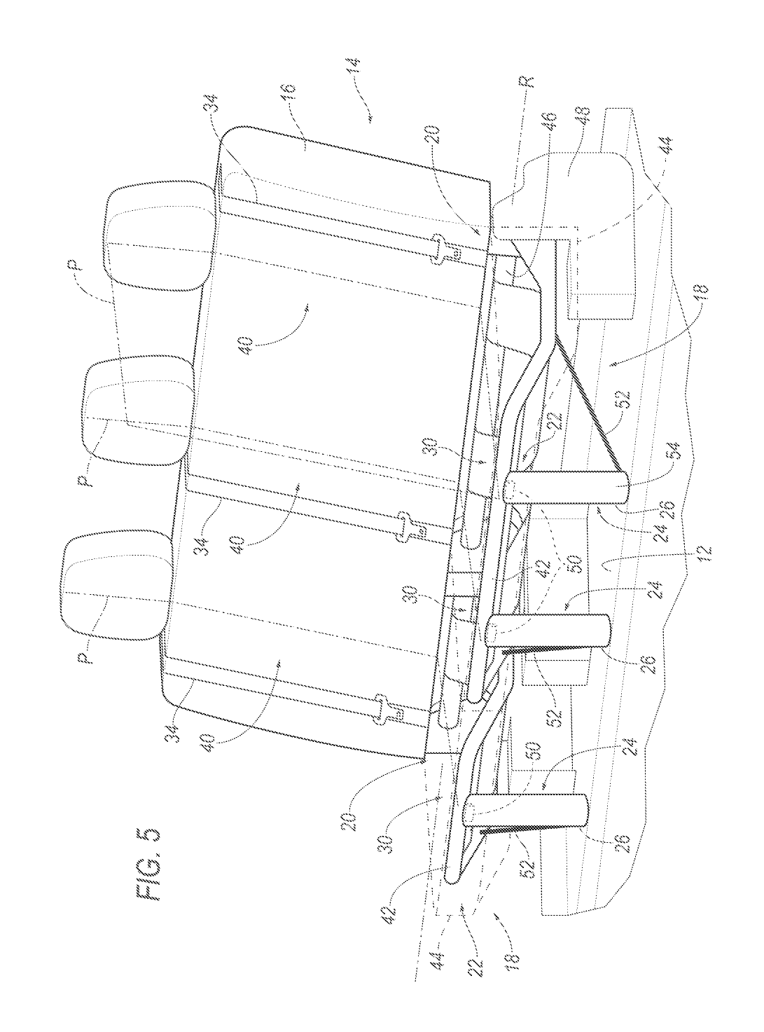

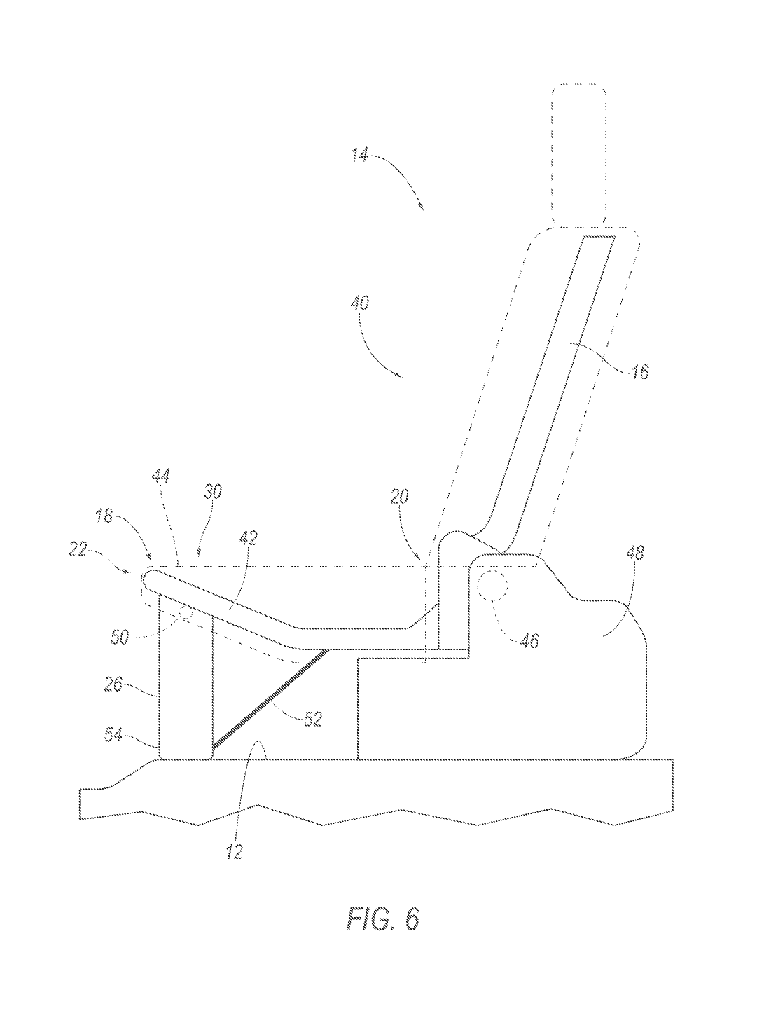

With reference to the Figures, wherein like numerals indicate like parts throughout the several views, a vehicle 10 includes a vehicle floor 12 and a vehicle seat 14 mounted to the vehicle floor 12. The vehicle seat 14 has a cross-seat axis CS. The vehicle seat 14 includes a seatback 16. The vehicle seat 14 includes a seat bottom 18 rotatably connected to the seatback 16 about a rotational axis R. The rotational axis R extends along the cross-seat axis CS. The seat bottom 18 includes a proximal end 20 at the seatback 16 and a distal end 22 distal to the seatback 16. An inflatable device 24 is fixed to the distal end 22 of the seat bottom 18. The inflatable device 24 has a wall 26 that is a thermoplastic elastomer, as described further below. The wall 26 defines an inflation chamber. The seat bottom 18 is rotatable relative to the seatback 16 about the rotational axis R between a deployed position (FIGS. 1-2 and 5-6) and a raised position (FIGS. 3-4). The inflatable device 24 is moveable with the seat bottom 18 between the deployed position and the raised position. With the seat bottom 18 in the deployed position, the inflatable device 24 is spaced from the floor 12 in an uninflated position (FIGS. 1-4) and is inflatable to the floor 12 to an inflated position (FIGS. 5-6).

In the deployed position, the seat bottom 18 is positioned to support one or more occupants, and in the raised position, the seat 14 and the floor 12 define a cargo area 28 between the seat 14 and the floor 12. When the seat bottom 18 is in the deployed position, the inflatable device 24 is below a leg-seating area 30 of the seat bottom 18. When seated on the seat 14, the legs of an occupant are seated on the leg-seating area 30 of the seat bottom 18. During certain vehicle impacts, the pelvis and/or legs of the occupant may be forced in a downward direction in compression against the seat bottom 18. The inflatable device 24 is inflated in response to certain vehicle impacts, and in such instances, the inflatable device 24, being below the leg-seating area 30 of the seat bottom 18, counteracts this downward force to control the kinematics of the occupant, including controlling the kinematics of the occupant relative to a lap belt 32 of a seatbelt assembly 34. Since the inflatable device 24 is fixed to the distal end 22 of the seat bottom 18 and extends downwardly to the floor 12 in the inflated position, the inflatable device 24 defines a load path from the distal end 22 of the seat 14 to the floor 12. When the seat bottom 18 is in the raised position, the inflatable device 24 is packaged on the distal end 22 of the seat bottom 18 outside the cargo area 28 to allow for ingress and egress of cargo in the cargo area 28. Examples of cargo 36 are shown in the Figures.

The vehicle 10 may be any suitable type of automobile, e.g., a passenger or commercial automobile such as a sedan, a coupe, a truck, a sport utility, a crossover, a van, a minivan, a taxi, a bus, etc. In the example shown in the Figures, for example, the vehicle 10 is a pickup truck. The vehicle 10 defines an occupant cabin 38. With reference to FIG. 1, the vehicle 10 defines a vehicle-longitudinal axis L extending between a front end (not numbered) and a rear-end (not numbered) of the vehicle 10. The vehicle 10 defines a vehicle-lateral axis A extending cross-vehicle from one side to the other side of the vehicle 10. The vehicle 10 defines a vertical axis V extending through the floor 12 and roof of the vehicle 10. The vehicle-longitudinal axis L, the vehicle-lateral axis A, and the vertical axis V are perpendicular relative to each other.

The vehicle 10 includes a vehicle body. The vehicle body may be of a unibody construction in which a vehicle frame and the vehicle body are a unit (including frame rails, pillars, roof rails, etc.). As another example, the vehicle body and a vehicle frame may have a body-on-frame construction (also referred to as a cab-on-frame construction) in which the vehicle body and vehicle frame are separate components, i.e., are modular, and the vehicle body is supported on and affixed to the frame. Alternatively, the vehicle body may have any suitable construction. The vehicle body may be of any suitable material, for example, steel, aluminum, and/or fiber-reinforced plastic, etc.

The vehicle body includes body panels. The body panels may include structural panels, e.g., rockers, pillars, roof rails, etc. The body panels may include exterior panels. The exterior panels may present a class-A surface, e.g., a finished surface exposed to view by a customer and free of unaesthetic blemishes and defects. The body panels include, e.g., a floor panel, a roof panel, doors, fenders, hood, decklid, etc. The vehicle body may define an occupant cabin 38 to house occupants of the vehicle 10.

The vehicle 10 includes the floor 12 and may include a roof. The roof may define the upper boundary of the occupant cabin 38 and may extend from the front end of the occupant cabin 38 to the rear end of the occupant cabin 38. The floor 12 is below the roof. The floor 12 defines the lower boundary of the occupant cabin 38 and may extend from the front end of the occupant cabin 38 to the rear end of the occupant cabin 38. The floor 12 may include the floor panel of the body and may include a covering, e.g., carpet. The seat 14 may be supported by the floor 12, i.e., the weight of the seat 14 is borne by the floor 12. Specifically, the seat 14 may be supported by the floor panel of the vehicle body. In other examples, the seat 14 may be supported by other body panels of the vehicle 10.

The vehicle 10 includes one or more seats 14 in the occupant cabin 38. The vehicle 10 may include any suitable number of seats 14. The seats 14 may be arranged in the occupant cabin 38 in any suitable position, i.e., as front seats, rear seats, third-row seats, etc. The seats 14 may be of any suitable type, e.g., a bench seat, a bucket seat, etc.

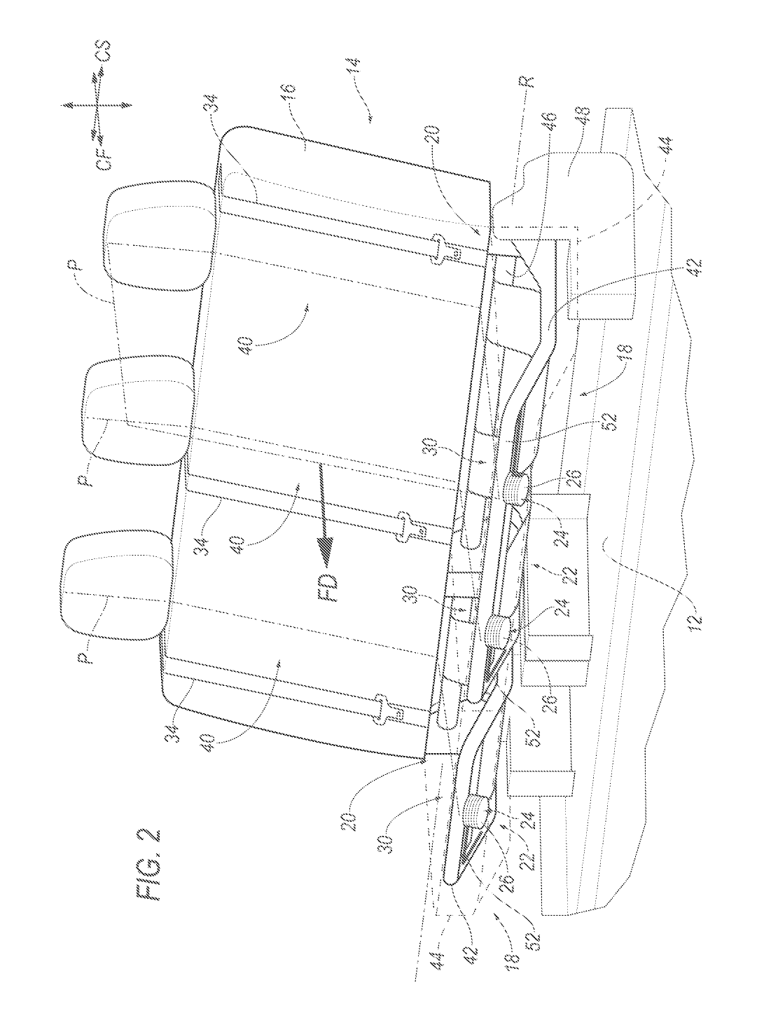

The seat 14 defines a seat-forward direction FD extending along a seat-forward axis CF. The seat-forward direction FD extends forward relative to the seat 14. The seat bottom 18 extends from the seatback 16 in the seat-forward direction FD. The occupant of the seat 14 faces in the seat-forward direction FD when properly seated in the seat 14. The seat bottom 18 extends from the seatback 16 in the seat-forward direction FD. The seat 14 defines the cross-seat axis CS and a seat-upright axis SU. In the example shown in the Figures, the vehicle seat 14 is elongated along the cross-seat axis CS. The seat-forward axis CF, the cross-seat axis CS, and the seat-upright axis SU are perpendicular to each other. The seat-forward axis CF is parallel with the vehicle-longitudinal axis L when the seat 14 is forward facing, the cross-seat axis CS is parallel with the cross-vehicle axis when the seat 14 is forward facing, and the seat-upright axis SU extends through the vehicle floor 12 and the vehicle 10 roof when the seatback 16 is in an upright position. An axis key showing axes parallel to axes CS, SCF, and SU of the seat 14 are generally shown in FIG. 2.

In the example shown in the Figures, the seat 14 is a second-row bench seat. In such an example, the seat 14, being a bench seat, includes multiple occupant-seating areas 40 (described in more detail below) and seatbelt assemblies 34 so that multiple occupants may be seated on the bench seat simultaneously. In the example shown in the Figures, the vehicle seat 14 defines three occupant-seating areas 40.

The seat bottom 18 and the seatback 16 each include a frame (including a seat-bottom frame 42 and a seatback frame) and may include upholstery 44 supported on the frame. The seat-bottom frame 42 and the seatback frame may include tubes, beams, etc. The seat bottom 18 frame and the seatback frame may be of any suitable material such as plastic (e.g., carbon fiber reinforced plastic (CFRP), glass fiber-reinforced semi-finished thermoplastic composite (organosheet), etc.) and/or metal (e.g., steel, aluminum, etc.).

The upholstery 44 of the seat 14 may include a covering and padding. The covering may be cloth, leather, faux leather, or any other suitable material. The covering may be stitched in panels around the frame. The padding may be between the covering and the frame and may be foam or any other suitable material.

In some examples, including the example shown in the Figures, the seat 14 includes two seat bottoms 18, i.e., a first seat bottom and a second seat bottom. Common numerals are used to identify common features of the two seat bottoms 18. In the example shown in the Figures, one seat bottom 18 is rotatable relative to the seatback 16 between the deployed position and the raised position independently of the second seat bottom 18. In some examples, one of the seat bottoms 18 may be fixed in a deployed position, and in other examples, both seat bottoms 18 may be rotatable relative to the seatback 16 between a deployed position and a raised position independently of the seat bottom 18. In the example shown in the Figures, one seat bottom 18 defines two occupant-seating areas 40 and the other seat bottom 18 defines one occupant-seating area 40, as described further below. In examples including two seat bottoms 18, the seat bottoms have separate frames, i.e., the seat-bottom frames are separate to allow for independent rotation of the seat bottoms relative to each other. In such examples, the seatback 16 extends across both the seat bottom 18 and the second seat bottom 18. In other examples, the seat 14 may include one seat bottom 18 that defines three occupant-seating areas 40.

The seat bottom 18 has the proximal end 20 and the distal end 22, as set forth above. The proximal end 20 is proximal to the seatback 16 at the rotational axis R. In examples including the seat bottom 18 and the second seat bottom 18, the proximal and the distal end 22 extend across the seat bottom 18 and the second seat bottom 18. The distal end 22 is distal to the seatback 16. The seat bottom 18 extends from the seatback 16 in the seat-forward direction FD from the seatback 16 to the distal end 22. The seat bottom 18 terminates at the distal end 22 and at the proximal end 20. Specifically, the seat bottom 18 terminates at a terminal distal edge of the distal end 22 and the seat bottom 18 terminates at a terminal proximal edge of the proximal end 20 of the seat bottom 18.

As set forth above, the seat 14 defines occupant-seating areas 40. The occupant-seating area 40 is the space occupied by an occupant properly seated on the seat 14. The occupant-seating area 40 is seat-forward of the seatback 16 and above the seat bottom 18. The occupant-seating area 40 is on top of the seat bottom 18 and on a front side of the seatback 16. In the example shown in the Figures, the seat 14 includes three occupant-seating areas 40. Two occupant-seating areas 40 are defined by the seat bottom 18 and one occupant-seating area 40 is defined by the second seat bottom 18. The numerical adjectives “first,” “second,” and “third,” used herein, including with reference to the occupant-seating areas 40 and the seat bottoms 18, etc., are identifiers to distinguish between components and do not indicate order or importance.

Each occupant-seating area 40 has a central plane P perpendicular to the seat bottom 18 and the seatback 16. The central plane P is the plane bisects the occupant-seating area 40 and is perpendicular to the cross-seat axis CS. The central plane P extends between the legs of the occupant when properly seated on the seat bottom 18. The inflatable device 24 is centered cross-seat on the central plane P in the uninflated position. In other words, the central plane P bisects the inflatable device 24. When in the inflated position, the inflatable device 24 may be centered cross-seat on the central plane P.

The seat 14 defines leg-seating areas 30. The seat 14 includes a leg-seating area 30 for each occupant-seating area 40. In the example, shown in the Figures, the seat 14 includes three leg-seating areas 30, with two leg-seating areas 30 defined by the seat bottom 18 and a leg-seating area 30 defined by the second seat bottom 18. The leg-seating area 30 is the portion of the seat bottom 18 occupied by the legs of an occupant properly seated on the seat 14. The central plane P of the occupant-seating area 40 bisects the leg-seating area 30.

The vehicle 10 includes a seatbelt assembly 34 for each occupant-seating area 40 of the seat 14. The seatbelt assembly 34 may be a three-point harness, meaning that the webbing is attached at three points around the occupant when fastened: an anchor, a seatbelt retractor, and a latch/buckle. The seatbelt assembly 34 may, in other examples, include another arrangement of attachment points.

The webbing may extend continuously from the seatbelt retractor to the anchor. For example, one end of the webbing feeds into the seatbelt retractor, and the other end of the webbing is fixed to the anchor. The anchor may, for example, be fixed to the seat 14. Alternatively, the anchor may be fixed to the vehicle body.

The webbing may be fabric, e.g., woven polyester. A clip slides freely along the webbing and, when engaged with the buckle , divides the webbing into a lap belt 32 and a shoulder belt.

The vehicle seat 14 and the vehicle floor 12 define the cargo area 28 therebetween when the seat bottom 18 is in the raised position. Since the seat bottom 18 is upright in the raised position (as described below), the cargo area 28 expands when the seat bottom 18 is rotated from the deployed position to the raised position. The cargo area 28 is designed, i.e., sized, shaped, and positioned, to receive cargo that an occupant wishes to store in the occupant cabin 38. The cargo area 28 extends upwardly from the floor 12 and from the seat 14 to a vehicle-forward seat 14, e.g., a front seat 14 in the example shown in the Figures.

The seatbelt retractor may be moveable from an unlocked position to a locked position by conventional mechanisms known in the art. In the unlocked position, the webbing may be extended from and retracted into the seatbelt retractor. In the locked position, the seatbelt retractor prevents extension of the webbing to limit the forward movement of the occupant. The seatbelt retractor may be in the unlocked position by default, i.e., in the absence of a sudden deceleration. The seatbelt retractor may change from the unlocked position to the locked position during a sudden deceleration of the vehicle 10, i.e., deceleration triggers components of the seatbelt retractor to change from the unlocked position to the locked position.

The seat bottom 18 is rotatably connected to seatback 16 about the rotational axis R. The seat bottom 18 may be directly connected to the seatback 16, e.g., through a hinge 46 on the seat bottom 18 and the seatback 16, or may be indirectly connected to the seatback 16, e.g., by direct connection between the seat bottom 18 and a base 48 of the seat 14, as described further below. The rotational axis R may extend along the cross-seat axis CS, e.g., may be parallel to the cross-seat axis CS. As set forth above, the seat bottom 18 is rotatable relative to the seatback 16 about the rotational axis R between the deployed position and the raised position. In the deployed position, the seat bottom 18 is positioned to support an occupant. For example, the seat bottom 18 is generally horizontal when the seat bottom 18 is in the deployed position. In the raised position, the seat bottom 18 is upright. For example, in the raised position, the seat bottom 18 is elongated in a plane that is generally vertical and may be generally parallel to a plane in which the seatback 16 is elongated.

The seat 14 may include one or more rotatable hinges 46 between the seat bottom 18 and the seatback 16. The rotatable hinge 46 may be of any suitable type, including, in some examples, those conventionally known to hinge 46 a rotatable seat bottom 18 to a seatback 16. The seat 14 may include a lock to lock the seat bottom 18 in the raised position and/or the deployed position.

The vehicle seat 14 is mounted to the vehicle floor 12. As an example, the vehicle seat 14 includes one or more bases 48 that support the seat bottom 18 and the seatback 16 on the floor 12, i.e., the weight of the seat bottom 18 and the seatback 16 is borne by base 48. The seatback 16 may be fixed to and stationary relative to the base 48. The seat bottom 18 may be fixed to the base 48 and/or the seatback 16, e.g., with the hinge 46. In the example shown in the Figures, the seatback 16 is fixed directly to the base 48, and the seat bottom 18 is rotatably fixed to the base 48 with the hinge 46.

When the seat bottom 18 is in the deployed position and the inflatable device 24 is in the uninflated position, the seat bottom 18 is cantilevered from the seatback 16. In other words, the seat bottom 18 extends from the seatback 16 at the proximal end 20 of the seat bottom 18 and is unsupported at the distal end 22 by components other than the rest of the seat bottom 18. In such examples, the seat bottom 18 is supported by the rotatable hinge 46 between the seat bottom 18 and the seatback 16 and/or the seat bottom 18 is supported by the base 48, i.e., all of the weight of the distal end 22 of the seat bottom 18 is borne by the rotatable hinge 46 and/or the base 48 through the rest of the seat bottom 18. In examples in which the seat bottom 18 is cantilevered, the weight of the legs of the occupant acts on the distal end 22 of the seat bottom 18 and is borne by the same component that bears the weight of the distal end 22. In such examples, the weight of the legs of the occupant creates a force moment acting on the distal end 22 about the component that supports the seat bottom 18 (e.g., the hinge 46, the base, etc.).

Each inflatable device 24 is a thermoplastic elastomer (TPE). The thermoplastic elastomer has both thermoplastic and elastomeric properties. The thermoplastic elastomer of the inflatable device 24 has properties that allow the inflatable device 24 to control the kinematics of an seat bottom 18. The inflatable device 24 being a thermoplastic elastomer aids in the deployment characteristics and the shape and size of the inflatable devices 24 in the inflated position. The thermoplastic elastomer may aid in packaging of the inflatable device 24. As described further below, the properties of the thermoplastic elastomeric of the inflatable device 24 allow the inflatable device 24 to be packaged on the seat-bottom frame 42 and provide control of the shape, size, and dimensions during inflation to position the inflatable device 24 to control the kinematics of a seat bottom 18, including downward forces on the seat bottom 18.

The thermoplastic elastomer (TPE) of the inflatable device 24 is inflatable from the uninflated position to the inflated position. Specifically, the inflatable device 24 has one or more walls 26 that are thermoplastic elastomer. The walls 26 of the inflatable device 24 define the inflation chamber of the inflatable device 24. The inflation chamber is supplied with inflation medium from an inflator 50 to inflate the inflatable device 24 and deploy the inflatable device 24 from the uninflated position to the inflated position. Specifically, the walls 26 of the inflatable devices 24 are solid, i.e., not woven, fabric, sewn, etc. The wall thickness of the inflatable device 24 may be, for example, 1-3 mm. In the uninflated position, one or more of the walls 26 of the inflatable device 24 may be flat and one or more of the walls 26 may be folded. The walls 26 that are folded unfold to allow the inflatable device 24 to expand from the uninflated position to the inflated position. The folded wall 26 may be accordion-shaped in the uninflated position. The wall 26 thickness of the walls 26 of the inflatable device 24 may remain generally constant from the uninflated position to the inflated position, e.g., with little or no stretch.

The inflatable device 24 may be of any suitable TPE, e.g., styrenic block copolymers, thermoplastic olefins, elastomeric alloys, thermoplastic polyurethanes, thermoplastic copolyesters, and thermoplastic polyamides. The inflatable devices 24 may be formed using any suitable manufacturing process, e.g., injection molding, blow molding, ultrasonic welding, etc. Specifically, the walls 26 of the inflatable devices 24 may be unitary with each other, i.e., a single, uniform piece of material with no seams, joints, fasteners, or adhesives holding the walls 26 together, i.e., formed together simultaneously as a single continuous unit. In other examples, the walls 26 of the inflatable device 24 may be non-unitary components, i.e., formed separately and subsequently assembled, e.g., by, welding, adhesive, etc.

The TPE of the inflatable device 24 may be formed with a class-A surface, e.g., the TPE may be textured in a molding process to match another class-A surface of the seat 14. In such examples, the inflatable devices 24 may be integrated into the seat bottom 18 without an additional covering, e.g., without being covered by the upholstery 44 of the seat bottom 18.

As set forth above, the vehicle 10 includes at least one inflator 50 (FIGS. 3 and 5-6) that inflates the inflatable devices 24. The inflator 50 is fluidly connected to the respective inflatable device(s) 24. The inflator 50 expands the inflatable device 24 with inflation medium, such as a gas, to move the inflatable device 24 from the uninflated position to the inflated position. The inflator 50 may be, for example, a pyrotechnic inflator that ignites a chemical reaction to generate the inflation medium, a stored gas inflator that releases e.g., by a pyrotechnic valve stored gas as the inflation medium, or a hybrid.

The inflator 50 may be supported by any suitable component. In the example shown in the Figures, the inflator 50 of each inflatable device 24 is disposed in the inflation chamber of the respective inflatable device 24. In such examples, the inflatable device 24 may include a clip that engages the inflators 50. The clip may be, for example, unitary with one of the walls 26 of the inflatable device 24, i.e., simultaneously formed together as a unit. In other examples, the inflator 50 may be exterior to the inflation chamber and connected to the inflation chamber with a fill tube. In such examples, the inflator 50 may be fixed to the seatback frame.

The inflatable device 24 is fixed to the seatback frame. In other words, the inflatable device 24 is anchored to the seatback frame and is immoveable relative to the seatback frame at the anchored point. The inflatable devices 24 may be secured to the seatback frame in any suitable manner such that the inflatable device 24 remains stationary at the anchored point in the event of an impact to the vehicle 10 and as the inflatable devices 24 move to the inflated positions. As an example, the inflatable device 24 may include one or more fasteners that engage the inflatable device 24 with the seat-bottom frame 42. The fasteners may be unitary with one of the walls 26 of the inflatable devices 24, i.e., a single, uniform piece of material with no seams, joints, fasteners, or adhesives holding them together. As shown in FIGS. 6A-6B, the fasteners may be Christmas tree fasteners engageable with holes in the seat-bottom frame 42. In other examples, the inflatable device 24 may be fixed to the seat-bottom frame 42with any suitable type of fastener to engage the inflatable devices 24 with the seat-bottom frame 42, e.g., clips, fasteners, etc. In some examples, in addition to or in the alternative to the fasteners, the inflatable device 24 may be adhered to the seat-bottom frame 42. Any combination of fasteners and adhesive may be used to secure the inflatable device 24 to the seat-bottom frame 42.

The vehicle seat 14 may include one inflatable device 24 for each occupant-seating area 40. In the example shown in the Figures, the vehicle seat 14 includes three occupant-seating areas 40 and three inflatable devices 24. In such examples, the inflatable devices 24 are centered on the central plane P of the respective occupant-seating area 40 at the distal end 22 of the seat bottom 18. Common numerals are used to identify common features of the inflatable devices 24.

The inflatable devices 24 are each fixed to the distal end 22 of the seat bottom 18. In other words, each inflatable device 24 is anchored to the seatback frame and is immoveable relative to the seatback frame at the anchored point. The inflatable devices 24 move as a unit with the distal end 22 of the seat bottom 18 as the seat bottom 18 moves between the deployed position and the raised position. The inflatable device 24 is mounted to the seat bottom 18, e.g., is mounted to the seat-bottom frame 42. As an example, the inflatable device 24 may be mounted to the seat-bottom frame 42. The inflatable devices 24 may be secured to the seatback frame in any suitable manner such that the inflatable device 24 remains stationary at the anchored point in the event of an impact to the vehicle 10 and as the inflatable devices 24 move to the inflated positions. As an example, the inflatable device 24 may include one or more fasteners that engage the inflatable device 24 with the seat-bottom frame 42. The fasteners may be unitary with one of the walls 26 of the inflatable devices 24, i.e., a single, uniform piece of material with no seams, joints, fasteners, or adhesives holding them together. The fasteners may be Christmas tree fasteners engageable with holes in the seat-bottom frame 42. In other examples, the inflatable device 24 may be fixed to the seat-bottom frame 42 with any suitable type of fastener to engage the inflatable devices 24 with the seat-bottom frame 42, e.g., clips, fasteners, etc. In some examples, in addition to or in the alternative to the fasteners, the inflatable device 24 may be adhered to the seat-bottom frame 42. Any combination of fasteners and adhesive may be used to secure the inflatable device 24 to the seat-bottom frame 42.

The inflatable devices 24 may be between the seat-bottom frame 42 and the upholstery 44 in the uninflated position. The upholstery 44 may conceal the inflatable devices 24 from view and from contact in the occupant compartment. The inflatable devices 24 may extend through the upholstery 44 from the seat-bottom frame 42 to the floor 12 in the inflated position. As an example, the upholstery 44 may include at least one tear seam through which one or more of the inflatable devices 24 separate during inflation from the uninflated position to the inflated position.

With the seat bottom 18 in the deployed position, the inflatable device 24 is spaced from the floor 12 in the uninflated position. Specifically, the inflatable device 24 is on the distal end 22 cantilevered from the seatback 16 and/or base. Each inflatable device 24 is inflatable to the inflated position. The inflatable devices 24 may independently inflatable to the inflated position.

The inflatable device 24 remains mounted to the seat-bottom frame 42 in both the uninflated position and the inflated position. In the inflated position, the inflatable device 24 extends to from the seat-bottom frame 42 to the floor 12. The inflatable device 24 contacts both the seat-bottom frame 42 and the floor 12 to an inflated position. The inflatable device 24 creates a load path from the seat-bottom frame 42 to the floor 12. During certain vehicle impacts that result in the legs of the occupant being forced in a downward direction in compression against the leg-seating area 30 of the seat bottom 18, the inflatable device 24 distributes the downward force to the legs from the seat-bottom frame 42 to the floor 12. Accordingly, the inflatable device 24 counteracts this downward force to control the kinematics of the occupant, including controlling the kinematics of the occupant relative to a lap belt 32 of the webbing of the seatbelt assembly 34. In examples in which the inflatable device 24 is centered on the central plane P of the occupant-seating area 40, as described above, this position of the inflatable device 24 delivers force from the center of the leg-seating area 30 at the distal end 22 of the seat bottom 18. In examples in which more than one inflatable device 24 inflates to the inflated position in response to certain vehicle impacts, the multiple inflatable devices 24 distribute the downward force to the floor 12 and define multiple load paths from the seat-bottom frame 42 to the floor 12.

In examples including multiple inflatable devices 24, the inflatable devices 24 in the inflated position are spaced from each other along the cross-seat axis CS when the inflatable devices 24 are in the inflated positions. In some examples, including the examples shown in the Figures, the width of the inflatable device 24 along the cross-seat axis CS is less than the width of the occupant-seating area 40 along the cross-seat axis CS.

In the examples shown in the Figures, the inflatable devices 24 are cylindrical. In other examples, the inflatable devices 24 may have any suitable shape, e.g., a rectangular cuboid, an ovoid, etc.

The vehicle seat 14 may include a tether 52 extending from the inflatable device 24 to the seat bottom 18. In such examples, the tether 52 may extend vehicle-rearward of the inflatable device 24 when the inflatable device 24 is in the inflated position. The inflatable device 24 in the inflated position has a bottom half 54 and the tether 52 may be connected to the bottom half 54. In the uninflated position, the tether 52 may be between the seat-bottom frame 42 and the upholstery 44. The tether 52 has one end fixed to the inflatable device 24 and another end fixed to the seat-bottom frame 42. The tether 52 positions the inflatable device 24 during and after inflation from the uninflated position to the inflated position.

The vehicle 10 includes a computer. The computer includes a processor and a memory. The computer may be a restraints control module. The memory includes one or more forms of computer readable media, and stores instructions executable by the computer for performing various operations, including as disclosed herein and including, for example, method shown in Figure and described below. For example, the computer may be a generic computer with a processor and memory as described above and/or may include an electronic control unit ECU or controller for a specific function or set of functions, and/or a dedicated electronic circuit including an ASIC (application specific integrated circuit) that is manufactured for a particular operation, e.g., an ASIC for processing sensor data and/or communicating the sensor data. In another example, the computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the computer. The memory may be of any type, e.g., hard disk drives, solid state drives, servers, or any volatile or non-volatile media. The memory may store the collected data sent from the sensors. The memory may be a separate device from the computer, and the computer may retrieve information stored by the memory via a vehicle 10 communication network, e.g., over a CAN bus, a wireless network, etc. Alternatively or additionally, the memory may be part of the computer, e.g., as a memory of the computer.

The computer is generally arranged for communications on the vehicle 10 communication network that may include a bus in the vehicle 10 such as a controller area network CAN or the like, and/or other wired and/or wireless mechanisms. Alternatively or additionally, in cases where the computer includes a plurality of devices, the vehicle 10 communication network may be used for communications between devices represented as the computer in this disclosure. Further, as mentioned below, various controllers and/or sensors may provide data to the computer via the vehicle communication network.

The vehicle 10 may include at least one impact sensor for sensing certain vehicle impacts (e.g., impacts of a certain magnitude, direction, etc.) and the computer is in communication with the impact sensor and the inflator 50. The computer may activate the inflator 50, e.g., provide an impulse to a pyrotechnic charge of the inflator 50 when the impact sensor senses certain vehicle impacts. The impact sensor may be configured to sense certain vehicle impacts prior to impact, i.e., pre-impact sensing. The impact sensor may be in communication with the computer. The impact sensor is configured to detect certain vehicle impacts. In other words, a “certain vehicle impact” is an impact of the type and/or magnitude for which inflation of the inflatable device 24 is designed i.e., “certain” indicates the type and/or magnitude of the impact. The type and/or magnitude of such “certain vehicle impacts” may be pre-stored in the computer, e.g., a restraints control module and/or a body control module. The impact sensor may be of any suitable type, for example, post contact sensors such as accelerometers, pressure sensors, and contact switches; and pre-impact sensors such as radar, LIDAR, and vision sensing systems. The vision sensing systems may include one or more cameras, CCD image sensors, CMOS image sensors, etc. The impact sensor may be located at numerous points in or on the vehicle 10.

The vehicle 10 may include at least one occupancy sensor. The occupancy sensor configured to detect occupancy of the vehicle 10 seats 14, e.g., detect an occupant in the occupant-seating area 40. The occupancy sensor may be visible-light or infrared cameras directed at the vehicle seat 14, weight sensors supported by the seat bottom 18, sensors detecting whether a seatbelt assembly 34 for the seat 14 is buckled, or other suitable sensors. The occupancy sensor provides data to the computer specifying whether the vehicle seat 14 is occupied or unoccupied and information regarding the type of occupant.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle comprising:
a vehicle floor;
a vehicle seat mounted to the vehicle floor, the vehicle seat having a cross-seat axis;
the vehicle seat including a seatback;
the vehicle seat including a seat bottom rotatably connected to the seatback about a rotational axis, the rotational axis extending along the cross-seat axis;
the seat bottom including a proximal end at the seatback and a distal end distal to the seatback; and
an inflatable device fixed to the distal end of the seat bottom, the inflatable device having a wall that is a thermoplastic elastomer, the wall defining an inflation chamber;
the seat bottom being rotatable relative to the seatback about the rotational axis between a deployed position and a raised position;
the inflatable device being moveable with the seat bottom between the deployed position and the raised position; and
with the seat bottom in the deployed position, the inflatable device being spaced from the floor in an uninflated position and being inflatable to the floor to an inflated position.

2. The vehicle as set forth in claim 1, wherein the seat bottom defines an occupant-seating area having a central plane perpendicular to the seat bottom and the seatback, the inflatable device being centered cross-seat on the central plane.

3. The vehicle as set forth in claim 2, wherein the width of the inflatable device along the cross-seat axis is less than the width of the occupant-seating area along the cross-seat axis.

4. The vehicle as set forth in claim 1, further comprising a second inflatable device fixed to the distal end of the seat bottom and inflatable from an uninflated position to an inflated position;
the second inflatable device having a wall that is a thermoplastic elastomer, the wall of the second inflatable device defining an inflation chamber;
the seat bottom defining a first occupant-seating area and a second occupant-seating area, the first occupant-seating area and the second occupant-seating area each having a central plane perpendicular to the seat bottom and the seatback;
the inflatable device being centered cross-seat on the central plane of the first occupant-seating area and the second inflatable device being centered cross-seat on the central plane of the second occupant-seating area.

5. The vehicle as set forth in claim 4, wherein the seat bottom is cantilevered from the seatback.

6. The vehicle as set forth in claim 4, wherein the width of the inflatable device along the cross-seat axis is less than the width of the first occupant-seating area along the cross-seat axis, and the width of the second inflatable device along the cross-seat axis is less than the width of the second occupant-seating area along the cross-seat axis.

7. The vehicle as set forth in claim 6, wherein the inflatable device and the second inflatable device are spaced from each other along the cross-seat axis when the inflatable device and the second inflatable device are in the inflated positions.

8. The vehicle as set forth in claim 4, wherein the inflatable device and the second inflatable device are spaced from each other along the cross-seat axis when the inflatable device and the second inflatable device are in the inflated positions.

9. The vehicle as set forth in claim 1, wherein the vehicle seat and the vehicle floor define a cargo area therebetween when the seat bottom is in the raised position.

10. The vehicle as set forth in claim 1, wherein the seat bottom includes a seat-bottom frame, the inflatable device being mounted to the seat-bottom frame.

11. The vehicle as set forth in claim 10, wherein the seat bottom includes upholstery, the inflatable device being between the seat-bottom frame and the upholstery in the uninflated position, and the inflatable device extending through the upholstery from the seat-bottom frame to the floor in the inflated position.

12. The vehicle as set forth in claim 1, further comprising a tether extending from the inflatable device to the seat bottom vehicle-rearward of the inflatable device when the inflatable device is in the inflated position.

13. The vehicle as set forth in claim 12, wherein the inflatable device in the inflated position has a bottom half, the tether being connected to the bottom half.

14. The vehicle as set forth in claim 12, wherein the seat bottom includes a seat-bottom frame and upholstery, the tether being between the seat-bottom frame and the upholstery in the uninflated position.

15. The vehicle as set forth in claim 1, wherein the wall of the inflatable device has the same wall thickness in the uninflated position and the inflated position.

16. The vehicle as set forth in claim 1, wherein the seat bottom is cantilevered from the seatback.
